(19) United States
(12) Patent Application Publication
(10) Pub. No.: US 2012/0330674 A1
(43) Pub. Date: Dec. 27, 2012

(54) HOSPITAL-ACQUIRED INFECTIONS DASHBOARD SYSTEMS AND METHODS

(76) Inventors: John Brimm, Kirkland, WA (US); James MacCubbin, Murray, UT (US); Gary Peterson, Murray, UT (US)

(21) Appl. No.: 13/401,284

(22) Filed: Feb. 21, 2012

Related U.S. Application Data
(60) Provisional application No. 61/444,983, filed on Feb. 21, 2011.

(51) Int. Cl. G06Q 50/22

(52) U.S. Cl. 705/2

(57) ABSTRACT

Methods, systems, and computer-readable media provide healthcare dashboards. An example method includes providing a plurality of dashboard components containing selectable data points. The plurality of dashboard components are associated with a plurality of types of healthcare content and are based on parameters received from a user. The example method includes automatically creating at least one alert when a data point departs from clinical norms. The clinical norms are defined in association with the dashboard components. At least one data point is associated with patient data. The example method includes receiving a selection of at least one alert from a user and providing a supplemental dashboard in response to the selection. The supplemental dashboard contains additional selectable data points related to at least the selected alert. The additional data points include at least a guideline, an assessment, and an action to facilitate additional user action.

### RELATED APPLICATIONS

This patent claims priority to U.S. Provisional Application Ser. No. 61/444,983, entitled “Hospital-Acquired Infections Dashboard Systems and Methods,” which was filed on Feb. 21, 2011 and is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, which are stored in a medical information system. Radiologist and/or other clinicians may review stored images and/or other information, for example.

Entities of healthcare environments operate according to a plurality of clinical workflows. Clinical workflows are typically defined to include one or more elements or actions to be taken in response to one or more events and/or according to a schedule. Events may include receiving a healthcare message associated with one or more aspects of a clinical record, opening a record(s) for new patient(s), receiving a transferred patient, and/or any other instance and/or situation that requires or dictates responsive action or processing.

### BRIEF SUMMARY

Methods, systems, and tangible computer-readable storage media provide healthcare dashboards. An example method includes providing a plurality of dashboard components containing selectable data points. The plurality of dashboard components are associated with a plurality of types of healthcare content and are based on parameters received from a user. The example method includes automatically creating at least one alert when a data point departs from clinical norms. The clinical norms are defined in association with the dashboard components. At least one data point is associated with patient data. The example method includes receiving a selection of at least one alert from a user and providing a supplemental dashboard in response to the selection. The supplemental dashboard contains additional selectable data points related to at least the selected alert. The additional data points include at least a guideline, an assessment, and an action to facilitate additional user action.

An example system includes a dashboard provider to provide a plurality of dashboard components containing selectable data points. The plurality of dashboard components are associated with a plurality of types of healthcare content and are based on parameters received from a user. The example dashboard provider is to automatically create at least one alert when a data point departs from clinical norms. The clinical norms are defined in association with the dashboard components. At least one data point is associated with patient data. The example dashboard provider is to receive a selection of at least one alert from a user and provide a supplemental dashboard in response to the selection. The supplemental dashboard contains additional selectable data points related to at least the selected alert. The additional data points include at least a guideline, an assessment, and an action to facilitate additional user action.

An example tangible computer-readable storage medium comprises instructions that, when executed, cause a computing device to provide a plurality of dashboard components containing selectable data points. The plurality of dashboard components are associated with a plurality of types of healthcare content and are based on parameters received from a user. The example instructions cause the computing device to automatically create at least one alert when a data point departs from clinical norms. The clinical norms are defined in association with the dashboard components. At least one data point is associated with patient data. The example instructions cause the computing device to receive a selection of at least one alert from a user and provide a supplemental dashboard in response to the selection. The supplemental dashboard contains additional selectable data points related to at least the selected alert. The additional data points include at least a guideline, an assessment, and an action to facilitate additional user action.

### BRIEF DESCRIPTION OF SEVERAL VIEWS OF THE DRAWINGS

FIG. 1 illustrates an example healthcare environment that may be used to implement systems and methods described herein.

FIG. 2 illustrates a block diagram of an example enterprise clinical information system of FIG. 1.

FIG. 3 illustrates a block diagram of an example multi-patient view that may be used to implement systems and methods described herein.

FIG. 4 illustrates a block diagram of an example dashboard provider of FIG. 2.

FIG. 5 illustrates an example dashboard created by the example dashboard provider of FIG. 4.

FIG. 6 illustrates an example supplemental dashboard associated with the dashboard of FIG. 5.

FIG. 7 illustrates another example dashboard created by the example dashboard provider of FIG. 4.

FIG. 8 illustrates a flow diagram of an example method of implementing the example dashboard provider of FIG. 4.

FIG. 9 illustrates another flow diagram of an example method of implementing the example dashboard provider of FIG. 4.

FIG. 10 illustrates another flow diagram of an example method of implementing the example dashboard provider of FIG. 4.

FIG. 11 illustrates another flow diagram of an example method of implementing the example dashboard provider of FIG. 4.

FIG. 12 illustrates another flow diagram of an example method of implementing the example dashboard provider of FIG. 4.

FIG. 13 is a block diagram of an example processor platform that may be used to execute the instructions of FIGS. 8-12 to implement the example enterprise clinical information system of FIG. 2, the example dashboard provider of FIG. 4, and/or, more generally, the example healthcare environment of FIG. 1.

The foregoing summary, as well as the following detailed description of certain examples of the present invention, will be better understood when read in conjunction with the appended drawings. For the purpose of illustrating the invention, certain examples are shown in the drawings. It should be understood, however, that the present invention is not limited to the arrangements and instrumentality shown in the attached drawings.

### DETAILED DESCRIPTION OF CERTAIN EXAMPLES

Entities of healthcare enterprises operate according to a plurality of clinical workflows. Clinical workflows are typically defined to include one or more elements or actions to be taken in response to one or more events and/or according to a schedule. Events may include receiving a healthcare message associated with one or more aspects of a clinical record, opening a record(s) for new patient(s), receiving a transferred patient, and/or any other instance and/or situation that requires or dictates responsive action or processing. The actions or elements of a clinical workflow may include placing an order for one or more clinical tests, scheduling a procedure, requesting certain information to supplement a received healthcare record, retrieving additional information associated with a patient, providing instructions to a patient and/or a healthcare practitioner associated with the treatment of the patient, and/or any other action useful in processing healthcare information. The defined clinical workflows can include manual actions or elements to be taken by, for example, an administrator or practitioner, electronic actions or elements to be taken by a system or device, and/or a combination of manual and electronic action(s) or element(s). While one entity of a healthcare enterprise may define a clinical workflow for a certain event in a first manner, a second entity of the healthcare enterprise may define a clinical workflow of that event in a second, different manner. In other words, different healthcare entities may treat or respond to the same event or circumstance in different fashions. Differences in workflow approaches may arise from varying preferences, capabilities, requirements or obligations, standards, protocols, etc. among the different healthcare entities.

The entities of a healthcare enterprise and/or entities from separate healthcare enterprises sometimes operate within a broader, interdependent information system, which hinder the ability of entities to customize clinical workflows. For example, the information system to which a healthcare entity belongs may place restrictions on changes to workflow applications or programs. Moreover, because some healthcare entities operate using systems, programs, devices, etc. from varying manufactures, software providers, etc., a lack of interoperability between the systems, programs, devices, etc. of each healthcare entity prohibits many customizations from realization. As a consequence of these example factors as well as additional or alternative factors, healthcare entities that desire customized clinical workflows are typically required to request such customizations from the manufacturers, software providers, etc. Furthermore, for such customizations to implemented or integrated into a healthcare information system, a wide range of system-interrupting updates or re-releases occur within the information systems.

Certain examples described herein provide a clinical knowledge platform, such as a dashboard provider, that enables healthcare institutions to improve performance, reduce cost, and increase quality of service. In certain examples, the clinical knowledge platform enables healthcare delivery organizations to improve performance against their quality targets, resulting in better patient care at a low, appropriate cost.

Certain examples facilitate better control over data. For example, certain example systems and methods enable care providers to access real-time patient information from existing healthcare information technology (IT) systems together in one location and compare this information against evidence-based best practices.

Certain examples facilitate better control over process. For example, certain example systems and methods provide condition- and role-specific patient views that enable a user to prioritize and coordinate care efforts with an institution's agreed upon practice standards and to more effectively apply resources.

Certain examples facilitate better control over patient care. For example, certain example systems and methods provide patient dashboards that highlight variations from desired practice standards and enable care providers to identify most critical measures within the context of performance-based care.

Certain examples leverage existing IT investments to standardize and centralize data across an organization. In certain examples, this includes accessing multiple systems from a single location, while allowing greater data consistency across the systems and users.

In certain examples, an advanced Service-Oriented Architecture (SOA) with a modern technology stack helps provide robust interoperability, reliability, and performance. The example SOA includes a three-fold interoperability strategy including a central repository (e.g., a central repository built from Health Level Seven (HL7) transactions), services for working in federated environments, and visual integration with third-party applications. Certain examples provide portable content enabling plug 'n play content exchange among healthcare organizations. A standardized vocabulary using common standards (e.g., LOINC, SNOMED CT, RxNorm, FDB, ICD-9, ICD-10, etc.) is used for interoperability, for example. Certain examples provide an intuitive user interface to help minimize end-user training. Certain examples facilitate user-initiated launching of third-party applications directly from a desktop interface to help provide a seamless workflow by sharing user, patient, and/or other contexts. Certain examples provide real-time (or at least substantially real time assuming some system delay) patient data from one or more IT systems and facilitate comparison(s) against evidence-based best practices. Certain examples provide one or more dashboards for specific sets of patients. Dashboard(s) can be based on condition, role, and/or other criteria to indicate variation(s) from a desired practice, for example.

Generally, the example methods, apparatus, systems, and/or articles of manufacture disclosed herein enable healthcare entities of an enterprise clinical information system (ECIS) to dynamically customize one or more clinical workflows. Among other functions and/or benefits, the ECIS supports healthcare practitioners in decision making processes by aggregating healthcare information across disparate enterprises and/or entities thereof and referencing collection(s) of data (e.g., guidelines, recommendations related treatment and/or diagnosis, studies, histories, etc.) to automatically generate supportive information to be communicated to one or more healthcare practitioners related to the aggregated healthcare information. While each entity operates in connection with the ECIS that is administered by a provider thereof, the examples disclosed herein enable each entity operating in connection with the ECIS to originate and/or modify one or more clinical workflows without relying on the provider of the ECIS to do so on behalf of the entity. In other words, although a healthcare entity is part of the ECIS and exchanges data with and via the ECIS, that entity can independently create and/or manage its clinical workflows using the examples disclosed herein. Furthermore, the examples disclosed herein enable entities of the ECIS to deploy or initiate the customized workflows without having to reboot or significantly interrupt the ECIS and/or the other components, workflows, etc., thereof. The example methods, apparatus, systems, and/or articles of manufacture disclosed herein and the advantages and/or benefits thereof are described in greater detail below in connection with the figures.

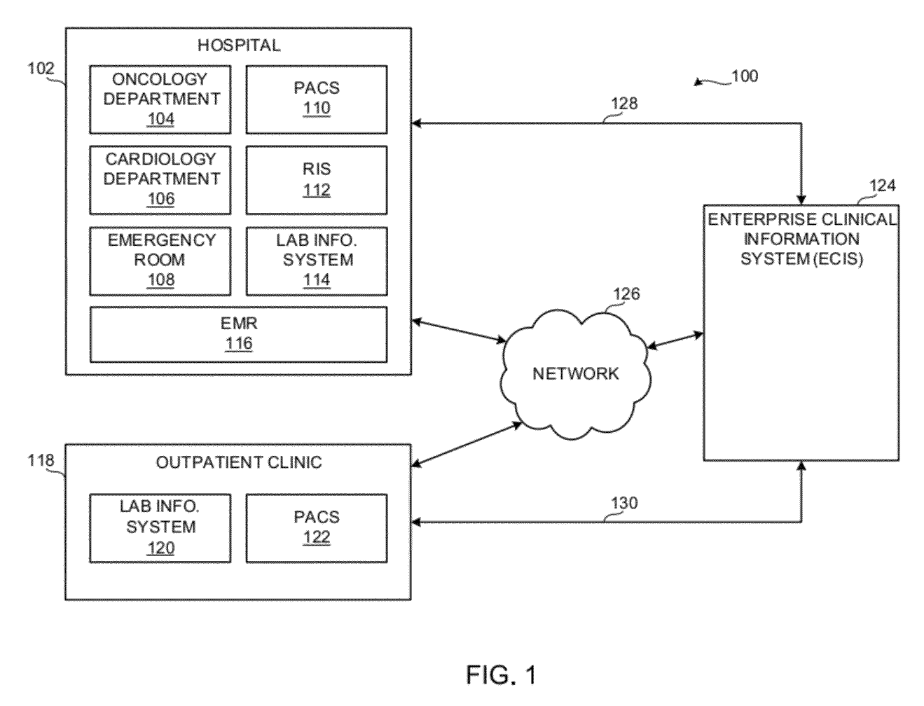

FIG. 1 is a block diagram of an example healthcare environment 100 in which the example methods, apparatus, systems, and/or articles of manufacture disclosed herein for clinical content-based healthcare may be implemented. The example healthcare environment 100 of FIG. 1 includes a first hospital 102 having a plurality of entities operating within and/or in association with the first hospital 102. In the illustrated example, the entities of the first hospital 102 include an oncology department 104, a cardiology department 106, an emergency room system 108, a picture archiving and communication system (PACS) 110, a radiology information system (RIS) 112, and a laboratory information system (LIS) 114. The oncology department 104 includes cancer-related healthcare practitioners, staff and the devices or systems that support oncology practices and treatments. Similarly, the cardiology department 106 includes cardiology-related healthcare practitioners, staff and the devices and/or systems that support cardiology practices and treatments. Notably, the example oncology department 104 of FIG. 1 has specifically designed clinical workflows to be executed in response to certain events and/or according to a schedule. At the same time, the example cardiology department 106 of FIG. 1 has specifically designed clinical workflows to be executed in response to certain events and/or according to a schedule that differ from the clinical workflows of the example oncology department 104 of FIG. 1. For example, the oncology department 104 may execute a first set of actions in response to receiving a Healthcare Level 7 (HL7) admission-discharge-transfer (ADT) message, while the cardiology department 106 executes a second set of actions different from the first set of actions in response to receiving a HL7 ADT message. Such differences may also exist between the emergency room 108, the PACS 110, the RIS 112 and/or the accounting services 114.

Briefly, the emergency room system 108 manages information related to the emergency care of patients presenting at an emergency room of the hospital 102, such as admission information, observations from emergency examinations of patients, treatments provided in the emergency room setting, etc. The PACS 110 stores medical images (e.g., x-rays, scans, three-dimensional renderings, etc.) as, for example, digital images in a database or registry. Images are stored in the PACS 110 by healthcare practitioners (e.g., imaging technicians, physicians, radiologists) after a medical imaging of a patient and/or are automatically transmitted from medical imaging devices to the PACS 110 for storage. The RIS 112 stores data related to radiology practices such as, for example, radiology reports, messages, warnings, alerts, patient scheduling information, patient demographic data, patient tracking information, and/or physician and patient status monitors, as well as enables exam order entry (e.g., ordering an x-ray of a patient) and image and film tracking (e.g., tracking identities of one or more people that have checked out a film). The lab information system 114 stores clinical information such as lab results, test scheduling information, corresponding practitioner(s), and/or other information related to the operation(s) of one or more labs at the corresponding healthcare facility. While example types of information are described above as being stored in certain elements of the hospital 102, different types of healthcare data may be stored in one or more of the entities 104-114, as the entities 104-114 and the information listed above is included herein as non-limiting examples. Further, the information stored in entities 104-114 may overlap and/or be combined into one or more of the entities 104-114. Each of the example entities 104-114 of FIG. 1 interacts with an electronic medical record (EMR) system 116. Generally, the EMR 116 stores electronic copies of healthcare records associated with, for example, the hospital 102 and the entities 104-114 thereof.

The example healthcare environment 100 of FIG. 1 also includes an outpatient clinic 118 as an example of another healthcare enterprise. The example outpatient clinic 118 of FIG. 1 includes a lab information system 120 and a PACS 122 that operate similarly to the corresponding entities of the example hospital 102. The lab information system 120 and the PACS 122 of the example outpatient clinic 118 operate according to specifically designed clinical workflows that differ between each other and the clinical workflows of the entities 104-114 of the hospital 102. Thus, differences in clinical workflows can exist between the entities of a healthcare enterprise and between healthcare enterprises in general.

In the illustrated example of FIG. 1, the hospital 102 and the outpatient clinic 118 are in communication with an ECIS 124 via a network 126, which may be implemented by, for example, a wireless or wired Wide Area Network (WAN) such as a private network or the Internet, an intranet, a virtual private network, a wired or wireless Local Area Network, etc. More generally, any of the coupling(s) described herein may be via a network. Additionally or alternatively, the example hospital 102 and/or the example outpatient clinic 118 are in communication with the example ECIS 124 via direct or dedicated transmission mediums 128 and 130.

Generally, the ECIS 124 supports healthcare information processing implemented by systems, devices, applications, etc. of healthcare enterprises, such as the hospital 102 and the outpatient clinic 118. The ECIS 124 is capable of processing healthcare messages from different entities of healthcare enterprises (e.g., the entities 104-114 of the hospital 102) that may generate, process and/or transmit the healthcare messages differently and/or using different formats, protocols, policies, terminology, etc. when generating, processing, and/or transmitting the healthcare messages. Moreover, the example ECIS 124 of FIG. 1 supports healthcare practitioners in decision making processes by aggregating healthcare information across disparate enterprises and/or entities thereof and referencing collection(s) of data to automatically generate suggestive and/or definitive data for communication to one or more healthcare practitioners related to the aggregated healthcare information.

Certain examples provide a library of standardized clinical content and proven best practices. Over time, this “library” of content may expand as healthcare organizations (e.g., the oncology department 104, the cardiology department 106, etc.) add to their own content modules. Because the content is standardized it can be shared and leveraged among organizations using the library and associated clinical knowledge platform. The library and platform help enable organizations to share best practice content. Thus, certain examples provide a clinical knowledge platform that enables healthcare delivery organizations to improve performance against their quality targets.

In certain examples, a dashboard provider enables creation of one or more dashboards based on the data/content most relevant to an organization at a given period of time. A clinical knowledge platform brings together real-time patient data from existing IT systems within an organization and allows for the comparison of this data against evidence-based best practices. The example dashboard provider leverages the platform to enable personalized “quality dashboards” to be created for specific sets of patients, based on condition, role, and/or other criteria. Variations from desired practice will be highlighted on each dashboard, enabling care providers to ensure better clinical outcomes and enrich patient care.

In this example, the clinical knowledge platform aggregates data from an organization's existing IT solutions. These can be solutions from the same and/or different manufacturer and/or provider. For example, as long as there is an HL7 or Web Services feed, the clinical knowledge platform can utilize the data from an existing solution. The existing IT solution(s) will continue to operate as they always have, and an organization can continue to use these solutions separate from the clinical knowledge platform if they so desire. However, the clinical knowledge platform and associated application(s) and/or workflow(s) can help to put organizations in greater control of their data by aggregating as much data from disparate IT solutions as possible.

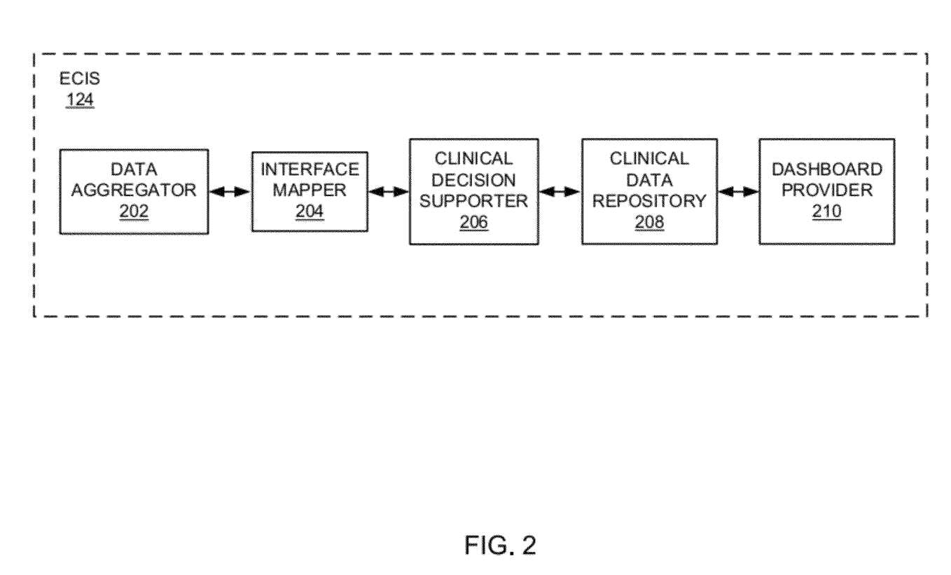

FIG. 2 illustrates an example enterprise clinical information system (ECIS) 124 of FIG. 1. The ECIS 124 of the illustrated example is a clinical knowledge platform and is used to aggregate data from various organizations and create various dashboard applications to improve healthcare delivery performance. The ECIS 124 of the illustrated example includes a data aggregator 202, an interface mapper 204, a clinical decision supporter 206, a clinical data repository 208, and a dashboard provider 210.

The data aggregator 202 of the illustrated example aggregates data from multiple sources. Aggregated data may include, for example, medication orders, radiology reports, microbiology, admit/discharge/transfer (ADT) message, lab results, specific observations, electronic medical record (EMR) data, etc. The data aggregator 202 passes aggregated data to the interface mapper 204.

The interface mapper 204 of the illustrated example provides terminology mapping and standardization to the aggregated data. As the different data sources are pulled into the interface mapper 204, content standardization occurs. It is this “standardization” that enables content from different IT sources to be used together. After the content is standardized, the interface mapper 204 passes the standardized content to the clinical decision supporter 206.

The clinical decision supporter 206 of the illustrated example ties clinical decision support mechanisms to the standardized content. The data and associated clinical decision support are then stored in the clinical data repository (CDR) 206. By combining the aggregated and standardized data with clinical decision support rules and alerts, the ECIS 124 may provide end-users with an understanding of important elements to which they should pay attention (and take action on) within the larger set of data they are considering when caring for a patient.

Combined data and clinical decision support mechanisms create valuable content that, when arranged properly, may be used to improve the quality of care provided. Organizations can elect to use the application(s) that are provided as a part of the example ECIS 124 and/or may choose to build their own clinical application(s) on the platform. The open architecture nature of the platform empowers organizations to build their own vision, rather than base their vision on the static/hard coded nature of traditional IT solutions.

The dashboard provider 210 of the illustrated example is used to provide and/or build application(s). For example, the dashboard provider 210 creates “quality dashboards” that display data via columns and rows in addition to individual patient “inspector” views. The dashboard provider 210 facilitates the creation and personalization of one or more quality dashboards by an end user. The flexible nature of the dashboard provider 210 empowers organizations to create dashboards of the aggregated data based on their needs at a given period of time. The organization may determine what data points they would like to include on each dashboard and, without significant IT resources, create a dashboard that reflects their vision. In addition, organizations can determine where on the dashboard they would like the information to be displayed and further adjust the view of the content via features such as “bolding” font, etc. When data is added to each dashboard, clinical decision support mechanisms attached to this data are displayed on the dashboard as well. For example, content related to treating a patient based on a particular use case may be included on a quality dashboard, along with alerts and notifications to indicate to end-users when desired outcomes are varying from defined clinical standards. Thus, organizations can create dashboards based on their own idea of “best practice” care for a given disease state.

In certain examples, since combined content and best practices have been standardized, content from one organization using the clinical knowledge platform may be easily shared with other organizations utilizing the platform. In addition, because the content within platform-related applications is standardized in the same manner, upgrades to the example platform can occur efficiently across organizations. That represents a dramatic change from prior IT solutions which require unique IT upgrades because they are usually uniquely customized to each organization in which they are installed.

While the example ECIS 124 has been illustrated in FIG. 2, one or more of the elements, processes and/or devices illustrated in FIG. 2 may be combined, divided, re-arranged, omitted, eliminated and/or implemented in any other way. Further, the data aggregator 202, the interface mapper 204, the clinical decision supporter 206, the clinical data repository 208, the dashboard provider 210, and/or, more generally, the example ECIS 124 of FIG. 2 may be implemented by hardware, software, firmware and/or any combination of hardware, software and/or firmware. Thus, for example, any of the example data aggregator 202, the interface mapper 204, the clinical decision supporter 206, the clinical data repository 208, the dashboard provider 210, and/or, more generally, the example ECIS 124 of FIG. 2 could be implemented by one or more circuit(s), programmable processor(s), application specific integrated circuit(s) (“ASIC(s)”), programmable logic device(s) (“PLD(s)”) and/or field programmable logic device(s) (“FPLD(s)”), etc. When any of the apparatus or system claims of this patent are read to cover a purely software and/or firmware implementation, at least one of the example data aggregator 202, the interface mapper 204, the clinical decision supporter 206, the clinical data repository 208, and/or the dashboard provider 210 are hereby expressly defined to include a tangible computer readable medium, such as a memory, Blu-ray, digital versatile disk (“DVD”), compact disc (“CD”), etc., storing the software and/or firmware. Further still, the example ECIS 124 of FIG. 2 may include one or more elements, processes and/or devices in addition to, or instead of, those illustrated in FIG. 2, and/or may include more than one of any or all of the illustrated elements, processes and devices.

Generally, content is information and experience that may provide value for an audience. Any medium, such as the Internet, television, and audio CDs, may deliver content as value-adding components. Content represents the deliverable, such as a DVD movie, as opposed to the delivery mechanism, a DVD player. As long as content conforms to the media standard, any compatible device can play it. Content, as used herein, is the externalization or parameterization of “the instructions” that tell applications how to work. For example, content is a collection of externalized information that tells software, in conjunction with data, how to behave. In certain examples, a clinical knowledge platform (e.g., the ECIS 124) takes in and executes content against data to render applications visually and behaviorally.

Content includes data read and interpreted by a program to define or modify presentation, behavior, and/or semantics of the program and/or of application data consumed by the program, for example. Content includes documents presented to a client by a program without modification, for example. Content may be created, stored, deployed, and/or retrieved independently of the creation and deployment of the program(s) consuming the data, for example. Content may be versionable to capture desired variation in program behavior and/or semantics, for example. Classes of content may include configuration content, preferences content, reference content, application content, etc. Content types may combine behaviors of two or more classes, for example.

Software vendors take many different approaches to customization. At one extreme, some vendors write different software for each customer or allow customers to write software. At the other extreme, a vendor has the same software for each customer, and all customization occurs through creating or modifying content. In certain examples, the same software may be used for each customer, and customization is handled through content. In healthcare, new laboratory tests, medications, and even diseases are constantly being discovered and introduced. Structuring this as content, where underlying software does not need to change, helps accommodate and use updated information.

In certain examples, many different content types, such as form definitions, data models, database schema, etc., are accommodated. In certain examples, each content type may be used differently and involve a distinct authoring tool. Thus, in certain examples, content may refer to “a collection of the content instances for all content types,” also called a content repository, knowledge repository, or knowledge assets. For example, a content instance is a specific member of a content type, such as a heart rate data model.

In certain examples, each content type is associated with a generic, extensible structure that content instances of the content type follows. An example clinical information system can specify content in an abstract way that does not presuppose a particular software implementation, for example. That is, another system, such as General Electric's Centricity® Enterprise, may consume content from a knowledge repository, apply a different set of software, and achieve the same behaviors. Additionally, an abstract content definition can more easily transition to a new system. If one can extract content from a legacy system, a knowledge repository may be able to import and reuse it. Such a capability helps reduce a large barrier to change for potential customers.

Content can change with time. In an example, a current knowledge repository can handle any “old” data entered into a system under the auspices of an older knowledge repository. Occasionally, a question may arise where someone could ask, “What did Dr. Smith see at some past time?” Under these circumstances, a current definition of a particular display may not correctly reflect the situation at the time. An example clinical information system (CIS), unlike other systems, can bring back the old form for visualizing the data since all knowledge assets are versioned and retained.

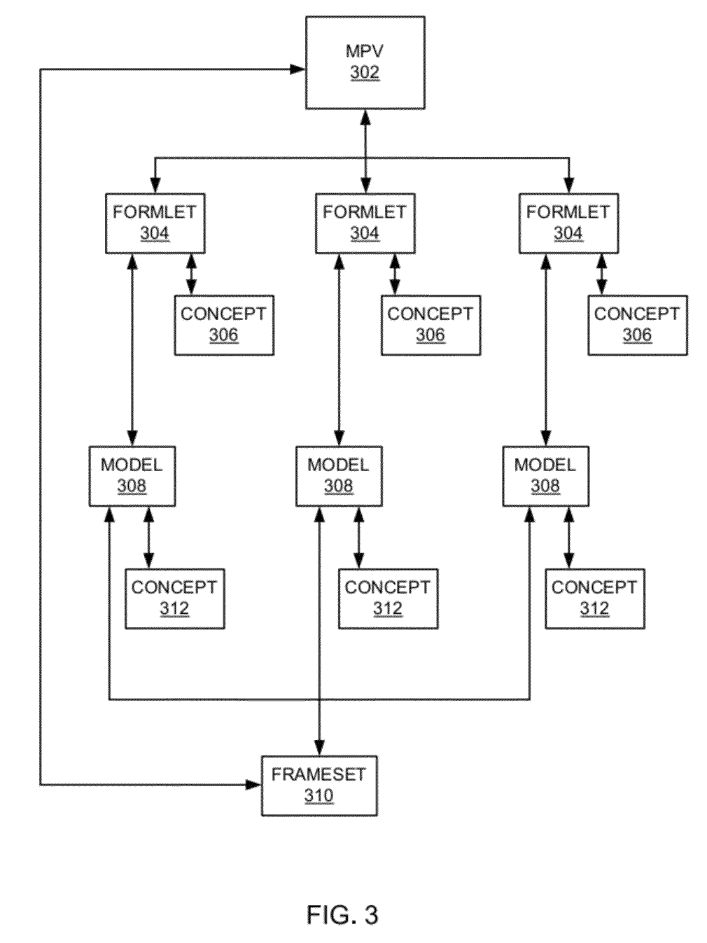

Content may need to vary for different circumstances. For example, a multi-patient view (MPV) (e.g., the MPV 302 of FIG. 3) may differ between an emergency department (ED) and labor and delivery settings. Each MPV has rows and columns of data specific to its setting. Context refers to being aware of and reacting distinctively to a location and other situational differences. For example, interpretation of a patient's low temperature can vary based on location. If it occurs in the recovery room after cardiopulmonary bypass with deliberate patient cooling, it means one thing. If the patient is in the ED after breaking through ice into a lake, it means something completely different. Context may vary based on user location, patient location, user role, and/or various other factors. In certain examples, content may be applied based on context.

Globalization is a process of adapting software so that it has no language references, before embedding capabilities to make it suitable for particular languages, regions, or countries. Having globalized it, a CIS may then translate it to other languages and cultures, called localization. Globalizing a software product involves creating content separate from the software. For example, embedded text (e.g., user messages), sort orders, radix characters, units of measure, data formats, currency, etc., may be removed and parameterized. References to languages, character sets, and fonts may also be removed, for example. In certain examples, while display representations may be local, terminology concepts are applied universally, making a rule, calculation, or other content based on one or more terminology concepts useable worldwide without modification.

FIG. 3 illustrates a block diagram of an example multi-patient view (MPV) 302 that may be used to implement systems and methods described herein. The MPV 302 includes a plurality of formlets 304. Each formlet 304 corresponds to a concept 306 and a model 308. A frameset 310 is also associated with each model 308, and each model 308 is associated with a concept 312, for example. The concepts 306 and 312 may contain content related to the formlets 304 and models 308 respectively. The models 308 may contain information regarding how to form the MPV 302 and how to interpret data and/or content. The formlets 304 may contain information on how to form the models into the MPV 302 and the frameset 310 may contain information on how to form a user interface for the MPV 302.

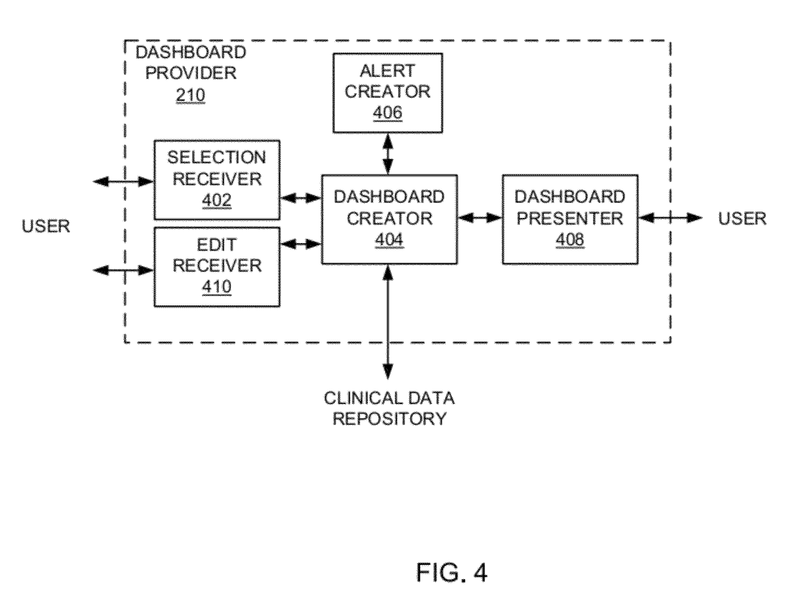

FIG. 4 illustrates a block diagram of the example dashboard provider 210 of FIG. 2. The dashboard provider 210 enables creation of one or more dashboards based on data and/or content most relevant to an organization at a given period of time. The ECIS 124 brings together real-time patient data from existing IT systems within an organization and the dashboard provider 210 allows for the comparison of this data against evidence-based best practices. The example dashboard provider 210 leverages the ECIS 124 to enable personalized “quality dashboards” to be created for specific sets of patients, based on condition, role, and/or other criteria. Variations from desired practice will be highlighted on each dashboard, enabling care providers to ensure better clinical outcomes and enrich patient care.

Dashboards are be built with aggregated data and/or content and provide a framework which can be applied to specific patients, practitioners, etc. based on user selections. For example, a user may use the dashboard provider 210 to design a dashboard based on a variety of parameters. For example, a user may build a dashboard based on dashboard type (e.g., hospital-based infections), organization (e.g., radiology, emergency, etc.), and/or user status (e.g., nurse, physician, etc.). A dashboard incorporates, for example, clinical standards, healthcare practices, relational information and/or data, rules, etc. Once a dashboard has been created, a user selects a patient and/or practitioner, for example, and the dashboard is displayed incorporating the selected patient and/or practitioner data. For example, a dashboard may specify a specific type of patient data and certain clinical standards associated with that patient data. Once a user is selected, the dashboard displays the patient data with alerts based on those clinical standards associated with that type of patient data. The dashboard provider 210 of the illustrated example includes a selection receiver 402, a dashboard creator 404, an alert creator 406, a dashboard presenter 408, and an edit receiver 410.

The selection receiver 402 of the illustrated example is used to receive selections from a user during the creation and/or use of a dashboard. For example, the dashboard provider 210 designs a dashboard based on a variety of dashboard context parameters. Dashboard context parameters help to shape the dashboard, including, for example, the type of information the dashboard will contain and/or display, the type of control the user will have over the dashboard, etc. For example, context parameters may include dashboard type (e.g., hospital-based infections), organization (e.g., radiology, emergency, etc.), and/or user status (e.g., nurse, physician, etc.). The selection receiver 402 is used to facilitate the selection of such parameters by a user. Once a dashboard has been created, the selection receiver 402 is used to select a patient and/or practitioner, for example. A user may build and/or select a dashboard to be displayed and then select a patient and/or practitioner to be incorporated into the dashboard using the selection receiver 402.

The dashboard creator 404 of the illustrated example creates dashboards. The dashboard creator 404 facilitates the creation and personalization of one or more dashboards by an end user. The flexible nature of the dashboard creator 404 empowers organizations and/or users to create dashboards of aggregated data based on their needs at a given period of time. The dashboard creator 404 of the illustrated example obtains aggregated data from the clinical data repository 208 of FIG. 2. The organization and/or user may determine what dashboard components they would like to include on each dashboard and, without significant IT resources, create a dashboard that reflects their vision. As described above, when data is added to each dashboard, clinical decision support mechanisms attached to this data (e.g., by the clinical decision supporter 206 of FIG. 2) are displayed on the dashboard as well. For example, content related to treating a patient based on a particular use case may be included on a quality dashboard, along with alerts and notifications to indicate to end-users when desired outcomes are varying from defined clinical standards. Thus, organizations can create dashboards based on their own idea of “best practice” care for a given disease state.

The dashboard creator 404 creates dashboards that include dashboard components, data points, content, alerts, etc. Dashboard components are broad types of information that a user may wish to include on a dashboard. Components may be of a type that is generic to dashboard type. For example, components may include patient name, room number, practitioner, comments, etc. Such components may be applicable to a variety of dashboards regardless of dashboard type (e.g., such components are applicable to both radiology and cardiology dashboards). Additionally or alternatively, dashboard components may be based on, for example, the dashboard context parameters received by the selection receiver 402. For example, a dashboard created for hospital-acquired conditions (e.g., infections) may include components such as infection risk, vitals, antibiotics, lab results, etc. Dashboard components may be selected by a user and/or recommended automatically by the dashboard creator 404 based on data contained in a clinical data repository (e.g., the CDR 208). For example, if the selection receiver 402 receives a selection to create a hospital-acquired condition dashboard, the dashboard creator 404 may provide related dashboard components to the user for inclusion in the dashboard. Additionally, a user may arrange components and specify the manner in which they are displayed via the selection receiver 402.

Dashboard components contain data points. Data points may be thought of as subsets of dashboard components that specify additional related categories of information and/or data. For example, a patient name category may include subsets such as gender and age. A vital category may include subsets such as heart rate and blood pressure. An infection risk category may include subsets related to specific risks (e.g., catheters). Data points may be selected by a user and/or recommended by the dashboard creator 404 based on data contained in a clinical data repository (e.g., the CDR 208) and/or clinical models. For example, if a certain dashboard component is selected, the dashboard creator 404 may provide related data points to the user for inclusion in the dashboard. When a dashboard is being formed, data points may be of a general nature, for example, specifying patient gender. When the dashboard is selected for use with a patient, data points may be associated with patient data, for example, specifying that the selected patient is female. Some data points may be of a general nature and applicable to all patients. For example, some data points may specify a certain healthcare standard and may remain unaltered by patient data.

To associate content with data points and/or components, the dashboard creator 404 accesses the clinical decision supporter 206 via the CDR 208 to access clinical decision support mechanisms attached to data points. Detailed clinical models (DCMs), such as clinical element models (CEMs), may be used to structure, organize, and/or associate content, clinical decision support mechanisms, and/or associated data points. Dashboard components may be automatically associated with content based on these clinical models. A clinical model may provide format and rules and associations for the clinical model. Clinical models may be combined to form a dashboard component and drive information, alerts, and functionality available through the dashboard using the healthcare content, rules, and associations. For example, content related to treating a patient based on a particular use case may be associated with the appropriate data point. Such content may be displayed on the dashboard or associated with the dashboard for selection and closer inspection by a user at a later time.

To create dashboards with alerts and notifications, the dashboard creator 404 utilizes the alert creator 406. The alert creator 406 of the illustrated example creates alerts based on aggregated data obtained from the clinical data repository 208. Alerts may be based on a review of models that indicate certain data relates to an alert in a certain way. Alerts are intended to illustrate to a user when healthcare standards, patient information (e.g., test results), etc. are deviating from clinical standards and/or expected outcomes, for example. The alert creator 406 may create, gather, and/or assign rules to dashboards (e.g., data points within a dashboard) based on relevant healthcare standards. For example, if the dashboard creator 404 is creating a dashboard involving hospital-based conditions, the alert creator 406 may used aggregated data to assign a rule to a data point based on best-practices to avoid hospital-based conditions. Such a rule may specify, for example, that a catheter should be used for a certain amount of time. Once the dashboard is selected and a patient and/or practitioner is selected for associating with the dashboard, the alert creator 406 may apply specific patient and/or practitioner data to rules to determine if any rules are violated. For example, if patient data (e.g., a data point) specifies that a catheter has been used for a time greater than the time specified by the rule, the alert creator 406 will create an alert to be displayed by the dashboard with the patient data.

Once a dashboard has been created and/or selected, the selection receiver 402 is used to select a patient and/or practitioner. A user may select a patient and/or practitioner to be incorporated into the dashboard using the selection receiver 402. For example, a user may select a single patient or a plurality of patients to be viewed in the dashboard. Additionally or alternatively, a user may select a practitioner and associated patients may be viewed in the dashboard. The dashboard creator 404 loads the selected dashboard interface (e.g., including dashboard components and data points) and the selected patient and/or practitioner. To load the selected dashboard, the dashboard creator 404 applies data associated with the selected patient and/or practitioner (e.g., patient data) to the dashboard components and/or data points. For example, if a dashboard component includes lab results, the dashboard creator 404 gathers lab results for the selected patient and loads them into the associated data points.

The dashboard creator 404 applies content and alerts to the patient data loaded into the dashboard. For example, the dashboard creator 404 executes content against the patient and/or practitioner data to render the dashboard visually and behaviorally. For example, content related to treating a patient based on a particular use case may be associated with a patient. Such content may be displayed on the dashboard or associated with the dashboard for selection and closer inspection by a user. For example, a patient may be prescribed a certain antibiotic and additional content (e.g., prescribing information) may be displayed on the dashboard upon selection of the antibiotic by the user.

As described above, the alert creator 406 is used by the dashboard creator 404 to determine alerts associated with patient data. The alert creator 406 applies rules to the patient data to determine if patient care and/or data conform to accepted best practices. The alert creator 406 accesses patient data via the dashboard creator 404 and accesses rules related to the patient data. Rules are created by the alert creator 406 based on data points, dashboard components, and/or content. If, for example, patient data relates to an amount of time a catheter has been used, the alert creator 406 access rules related to catheter best care standards. The alert creator 406 applies the rules to the patient data and determines if the patient data violates the rules. For example, a rule related to catheter best practices may indicate an amount of time a catheter is to be used. If patient data indicates that a catheter has been used for a time longer than that indicated in the rule, the alert creator 406 determines that the patient data violates the rule. If patient data violates the rules, the alert creator 406 creates an alert for display in the dashboard with the patient data. The alert may be a physical indicator to illustrate to a user that patient data violates best care standards.

The dashboard presenter 408 of the illustrated example is used to display dashboards created by the dashboard creator 404. The dashboard presenter 408 may present dashboards via, for example, a graphical user interface. The presented dashboard includes dashboard components with their associated data points, for example. The appropriate patient and/or practitioner data are displayed within at least some of the data points. Content associated with the patient and/or practitioner data are displayed and/or certain data points may be selected by a user to display additional content. Alerts are presented to the user based on the patient and/or practitioner data that violates patient care standards. Such alerts may be selected by the user to display additional content and/or a supplemental dashboard (e.g., additional information regarding best care practices).

A user may select a data point and/or an alert displayed within a dashboard via the selection receiver 402. If the selection receiver receives a selection of data and/or an alert, the dashboard creator 404 provides a supplemental dashboard. For example, a user may select an alert and/or patient data and additional content that provides additional information relating to patient best care practices may be displayed. The selection of a data point and/or alert allows a user to drill down within the dashboard for greater inspection of data points included in the dashboard and/or receive additional information related to the data point and/or alert. In some examples, a user selects an alert and the dashboard creator 404 provides a supplemental dashboard that contains guidelines, assessments, and actions to facilitate user action. A guideline is information related to clinical norms for the associated data point and/or patient data. An assessment is information related to the associated data point and/or patient data. The action facilitates additional user actions such as entering and order, suggesting a medication, editing a data point, etc. to assist the user in aligning patient care with clinical norms.

The edit receiver 410 of the illustrated example facilitates additional user action by receiving edits from a user. For example, once a dashboard has been displayed for a particular patient and/or practitioner, a user may select certain information and/or data points in the dashboard to edit. Such edits may be based upon, for example, updated patient information, alerts, recommendations, additional patient information, scheduling, etc.

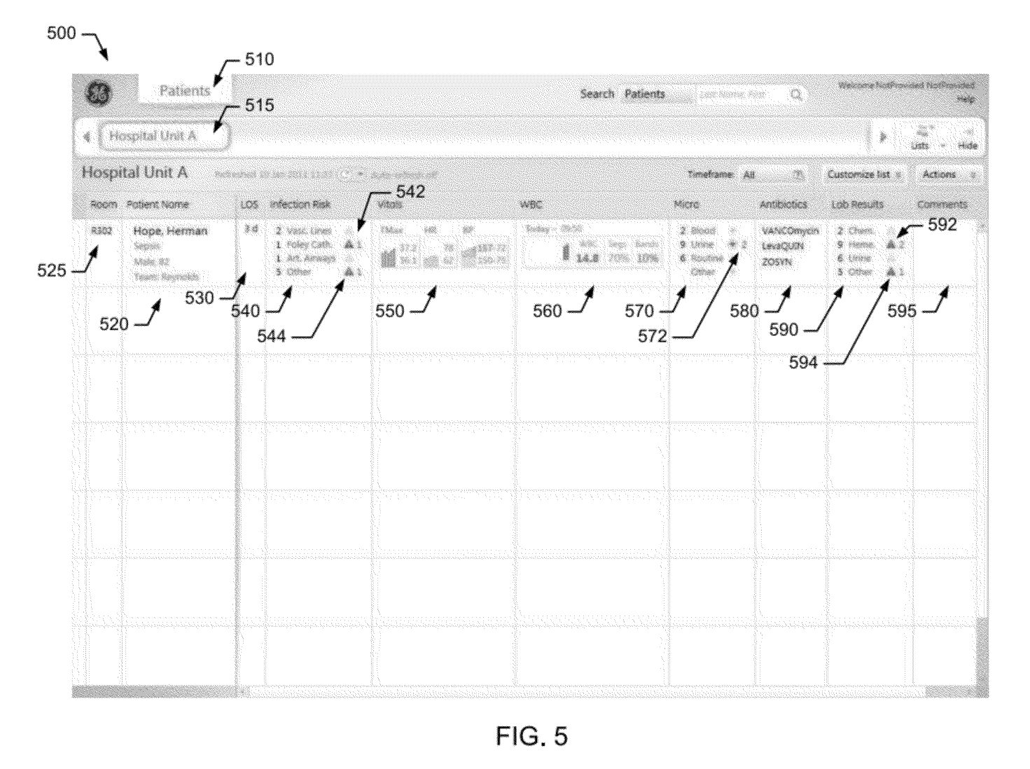

The dashboard provider 210 of the illustrated example may be used to facilitate detection and prevention of hospital-acquired conditions (e.g., infections) in patients at risk for such conditions. Example dashboards to facilitate such detection and prevention are described in greater detail below in connection with FIGS. 5-7.

While the example dashboard provider 210 has been illustrated in FIG. 4, one or more of the elements, processes and/or devices illustrated in FIG. 4 may be combined, divided, re-arranged, omitted, eliminated and/or implemented in any other way. Further, the selection receiver 402, the dashboard creator 404, the alert creator 406, the dashboard presenter 408, the edit receiver 410, and/or, more generally, the example dashboard provider 210 of FIG. 4 may be implemented by hardware, software, firmware and/or any combination of hardware, software and/or firmware. Thus, for example, any of the example selection receiver 402, the dashboard creator 404, the alert creator 406, the dashboard presenter 408, the edit receiver 410, and/or, more generally, the example dashboard provider 210 of FIG. 4 could be implemented by one or more circuit(s), programmable processor(s), application specific integrated circuit(s) (“ASIC(s)”), programmable logic device(s) (“PLD(s)”) and/or field programmable logic device(s) (“FPLD(s)”), etc. When any of the apparatus or system claims of this patent are read to cover a purely software and/or firmware implementation, at least one of the example selection receiver 402, the dashboard creator 404, the alert creator 406, the dashboard presenter 408, and/or the edit receiver 410 are hereby expressly defined to include a tangible computer readable medium, such as a memory, Blu-ray, digital versatile disk (“DVD”), compact disc (“CD”), etc., storing the software and/or firmware. Further still, the example dashboard provider 210 of FIG. 4 may include one or more elements, processes and/or devices in addition to, or instead of, those illustrated in FIG. 4, and/or may include more than one of any or all of the illustrated elements, processes and devices.

As described above, some example dashboard providers 210 facilitate automated organization and presentation of information. Some example dashboard providers 210 provide an ability to graphically overview information and drill down for further content. Some example dashboard providers 210 facilitate greater surveillance (e.g., detection and prevention) of a patient population. Some example dashboard providers 210 provide a concentrated dashboard view. Some example dashboard providers 210 facilitate a monitoring and prevention workflow.

Certain examples of the dashboard provider 210 of FIG. 4 facilitate detection and prevention of hospital-acquired conditions (e.g., infections) in patients at risk for such conditions. Many times, hospital-acquired conditions are picked up (e.g., acquired) at a hospital when a patient has been there for a certain period of time (e.g., more than two days). These conditions account for a large amount of healthcare expenses and may even cost patients their lives. Often times, additional costs attributable to these conditions are not reimbursable by support programs such as Medicare. Current techniques to detect and/or prevent such conditions are implemented in a manual, ad hoc manner; there is no organized, automated way to detect or prevent these conditions.

Hospital-acquired condition types and/or situations may include one or more of: 1. a urinary catheter is in place and the patient acquires an infection; 2. a central line is in place and the patient acquires an infection; 3. peripheral intravenous line(s) (IVs) are in place and a patient acquires an infection; 4. arterial line(s) are in place and a patient acquires an infection; 5. a surgical wound infection; 6. ventilator-associated pneumonia (VAP); 7. sepsis generally (blood stream infection); etc.

In attempting to tackle such hospital-acquired condition problems, healthcare providers may consider the following two questions: 1. “Can these conditions be detected earlier or treatment shortened?” and 2. “Can these conditions be prevented in some way?”

Some example dashboard providers 210 provide a hospital-acquired condition detection solution. Some example dashboard providers 210 may provide dashboards that include columns having information regarding infection risks, temperature, white blood cell count, what the culture results are, antibiotics the patient is on, etc. Using a dashboard to surface this information together (rather than spread out), detection of a potential and/or existing condition may be facilitated for a patient. Recognizing a condition is the first step; what to do about a condition is a second step.

Some example dashboard providers 210 assist in prevention of conditions. For example, some example dashboard providers 210 facilitate the consideration of questions such as, “Is a risk of putting a line/catheter in place worth the reward that is caused by it?” Any time a tube is inserted through an orifice or skin, there is a risk to the patient, and those risks can be listed for review in a dashboard by an example dashboard provider 210. Additionally, a length of time a line/catheter is left it in place can be important. For example, the longer an object is left in the patient, the higher the risk for infection. Therefore, a length of time that something has been in place may be prominently displayed by an example dashboard provider 210, and, as each object approaches a threshold of whether it should be removed, a reminder or alert that it is time to consider removing the object is highlighted to a user.

For each invasive mechanism, nurses and/or other practitioners have defined a set of things to try to do. For example, if a patient has an IV, a nurse will assess the insertion site periodically and will make note of redness, infiltration, etc. The nurse will change tubing, dressing, etc., at some interval. If there are things that are not being done as they should be done (e.g., according to accepted best practices), then such actions should be brought to users' attention. Some example dashboard providers 210 bring protocols and information together into one dashboard to track how long an object has been in a patient, show intervention (or lack thereof), and show if there are abnormal findings for an inserted object, an intervention, etc. In current systems, there is not an effective way to communicate to a nurse or doctor that they have not performed some action or have overlooked information and/or some status.

FIG. 5 illustrates an example dashboard 500 created by the example dashboard provider of FIG. 4. As shown in the example dashboard 500, a set of a nurse or doctor's patients and/or patients 510 for a particular location 515 (e.g., hospital unit A) are provided with a set of information to help understand a status of a patient relative to his or her risk of developing infection. As demonstrated in the example infection dashboard 500, a patient 520 in a room 525 is shown for a practitioner associated with the patient 520. The patient dashboard entry also shows a length of stay (LOS) 530 for the patient 520 (e.g., three days).

The example dashboard 500 also includes an infection risk 540, vitals 550, white blood cell (WBC) count 560, microbiology (Micro) results 570, antibiotics 580, lab results 590, comments 595, etc.

The micro column 570 of the example 500 indicates two urine cultures have come back positive (see, e.g., 572). An indicator 592 in lab results 590 in the example of FIG. 5 shows areas/results of potential concern. In the example of FIG. 5, the infection risk 540 provides one or more indicators 542, 544 to indicate that one or more of these risks is of concern (e.g., the catheter has been in longer than it should have been).

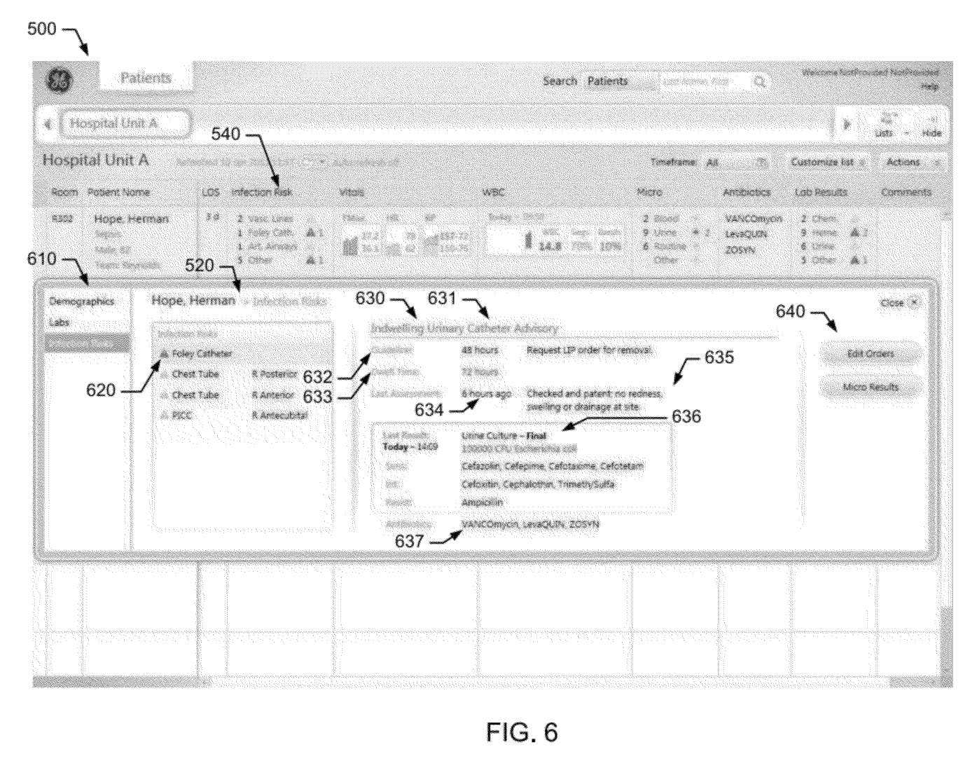

Each component (e.g., section) of the example dashboard 500 (e.g., the patient 520, the room 525, LOS 530, infection risk 540, vitals 550, antibiotics 580, etc.) is generated using a model associating content which organizes data and functionality to form a portion or cell of the interface. The cells can be in turn associated and additional views may be generated. An indicator (e.g., alert) may be selected and a supplement dashboard may be provided to provide additional information and/or facilitate additional user action. For example, the indicator 540 may be selected and the supplemental dashboard 610 of FIG. 6 can be generated as a result.

FIG. 6 illustrates an example supplemental dashboard 610 associated with the dashboard 500 of FIG. 5. As shown in the example dashboard 500 of FIG. 6, a user may select an item, such as infection risk 540 to pull up the supplemental dashboard 610 with further detail regarding infection risk(s) for the patient 520. A user can then select a listed risk 620 (e.g., Foley catheter) to view more detail 630. The example indwelling urinary catheter advisory detail 630 of the example dashboard 610 provides a location 631, a guideline time of insertion 632, an actual dwell time 633, a last assessment time 634 and remarks 635, relevant lab result(s) 636, antibiotics the patient is on 637, etc. In certain examples, other information (e.g., vitals, WBC, micro, labs, etc.) can be expanded to provide additional, detail, alerts, and/or suggests similar to the example shown in FIG. 6. In certain examples, actions may be included (e.g., different antibiotic(s) may be suggested, order(s) facilitated, etc.) to help prevent, detect, and/or treat infection in the patient. For example, the action 640 allows a user to edit orders to conform patient care to best practices.

Hospital acquired conditions may include, for example, a surgical site infection (SSI), a central line associated bloodstream Infection (CLABSI), ventilator-associated pneumonia (VAP), a catheter associated urinary tract infection (CAUTI), Clostridium difficile-associated disease (CDI), Sepsis, Decibitus ulcers, etc. In some examples, compromises to a patient body's natural defenses (e.g., A-lines, central and/or peripheral lines, ventilators, urinary catheters, surgical wounds, etc.) may be identified and used in the patient's information display. In some examples, a Foley Catheter entry for a patient infection risk may be selected to provide additional information about that Foley Catheter insertion for the patient. Data entry may include a risk/site start/stop time, practitioner action (e.g., dilation and curettage (D/C, continue, etc.), associated intervention(s), assessment(s), treatment(s) (e.g., change dressing, etc.), etc., at defined interval(s). Nurse charting (e.g., observations), including assessments, may be provided. Culture results (e.g., atomic), interim and/or final, may be provided, along with organisms and/or sensitivities, for example. Medications (e.g., orders) and/or antibiotics may be provided. In some examples, removal of an intrusion to the patient's body (e.g., a line), cleaning of an insertion site, assessment of an insertion site, prescription of medication, etc., may be facilitated via information, alert(s), and/or suggest(s) graphically provided.

Some example dashboard providers 210 provide systems and methods that present a summary of all compromises of a patient's body in a single view and an assessment of whether or not there is/may be a problem. Some example dashboard providers 210 facilitate prevention, detection, and/or treatment workflow(s) based on the gathered and displayed information.

In some example dashboards, a user may visually see where a value has gone out of bounds and where a value has stayed inbounds from a value graphing standpoint. Certain examples utilize a heat map to visualize deviations in value. Certain examples put information into an ontology (e.g., categorizing), make relationships/associations with the items, etc.

Some example dashboard providers 210 provide one or more treatment recommendations. For example, culture results are compared against a patient's sensitivities and resistances to determine that an infection is not being guarded against with current antibiotics. In certain examples, an interface may highlight current antibiotic(s) that are not the right one(s) for a particular infection and/or patient.

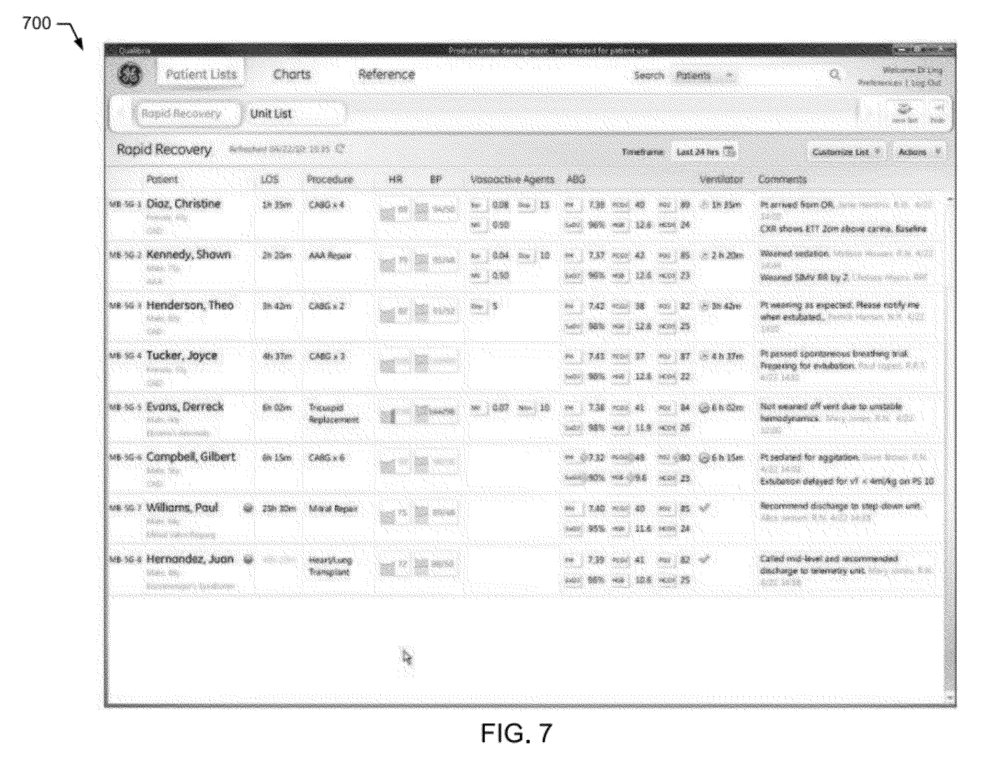

FIG. 7 illustrates another example dashboard 700 created by the example dashboard provider of FIG. 4. FIG. 7 depicts the example dashboard 700 on which quality information for one or more patients in a hospital unit or department (e.g., rapid recovery) can be tracked and displayed. A quality dashboard leveraging stored content and a clinical knowledge platform can be used to generate a quality dashboard, such as the example 700, for a particular customer/user. Such a dashboard 700 may utilize aggregated data stored in a clinical data repository associated with the platform.

As illustrated in the example of FIG. 7, an intensive care unit (ICU) may track care of cardiac surgery patients in a high throughput ICU setting. A quality dashboard 700 may highlight data points specified by a customer to provide best practices to user(s).

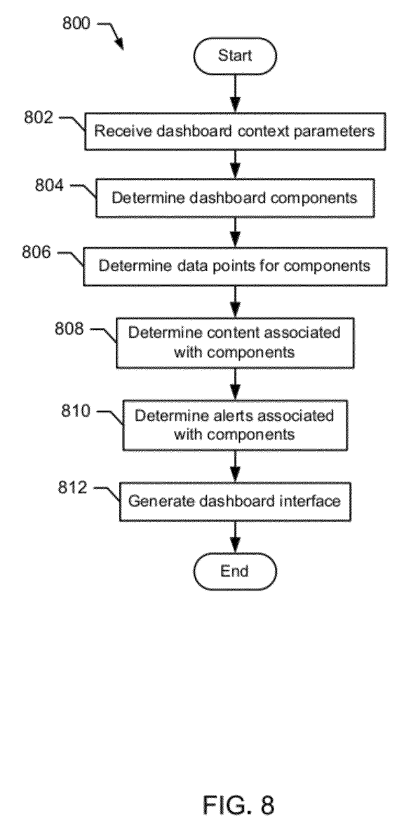

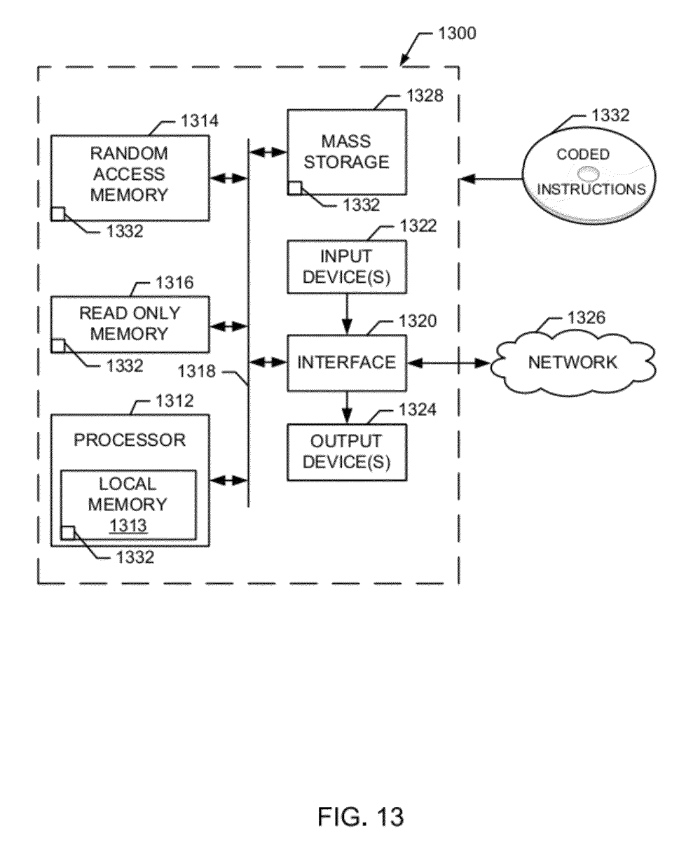

Flowcharts representative of example machine readable instructions for implementing the example dashboard provider 210 of FIG. 4 are shown in FIGS. 8-12. In these examples, the machine readable instructions comprise a program for execution by a processor such as the processor 1312 shown in the example processor platform 1300 discussed below in connection with FIG. 13. The program may be embodied in software stored on a tangible computer readable medium such as a compact disc read-only memory (“CD-ROM”), a floppy disk, a hard drive, a digital video disc (DVD), Blu-ray disk, or a memory associated with the processor 1312, but the entire program and/or parts thereof could alternatively be executed by a device other than the processor 1312 and/or embodied in firmware or dedicated hardware. Further, although the example program is described with reference to the flowcharts illustrated in FIGS. 8-12, many other methods of implementing the example dashboard provider 210 may alternatively be used. For example, the order of execution of the blocks may be changed, and/or some of the blocks described may be changed, eliminated, or combined.

As mentioned above, the example processes of FIGS. 8-12 may be implemented using coded instructions (e.g., computer readable instructions) stored on a tangible computer readable medium such as a hard disk drive, a flash memory, a read-only memory (“ROM”), a CD, a DVD, a Blu-Ray, a cache, a random-access memory (“RAM”) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 8-12 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 8 illustrates a flow diagram of an example method 800 of using the dashboard provider 210 of FIG. 4. The example method 800 illustrates a manner in which a dashboard may be created and/or designed by a user to facilitate a workflow and/or review process of patient and/or practitioner data. Initially, to create a dashboard, the selection receiver 402 receives selections of dashboard context parameters (block 802). Dashboard context parameters help to shape the dashboard, including, for example, the type of information the dashboard will contain and/or display, the type of control the user will have over the dashboard, etc. For example, context parameters may include dashboard type (e.g., hospital-based infections), organization (e.g., radiology, emergency, etc.), and/or user status (e.g., nurse, physician, etc.). A user may input context parameter selections via, for example, a user interface.

The dashboard creator 404 is used to determine dashboard components for the dashboard (block 804). Dashboard components are broad types of information that a user may wish to include on a dashboard. Components may be of a type that is generic to dashboard type. For example, components may include patient name, room number, practitioner, comments, etc. Such components may be applicable to a variety of dashboards regardless of dashboard type (e.g., such components are applicable to both radiology and cardiology dashboards). Additionally or alternatively, dashboard components may be based on, for example, the dashboard context parameters received by the selection receiver 402. For example, a dashboard created for hospital-acquired conditions may include components such as infection risk, vitals, antibiotics, lab results, etc. Dashboard components may be selected by a user and/or recommended by the dashboard creator 404 based on data contained in a clinical data repository (e.g., the CDR 208). For example, if the selection receiver 402 receives a selection to create a hospital-acquired condition dashboard, the dashboard creator 404 may provide related components of information to the user for inclusion in the dashboard. Additionally, a user may arrange components and specify the manner in which they are displayed via the selection receiver 402.

The dashboard creator 404 is used to determine data points for the determined dashboard components (block 806). Dashboard components contain data points. Data points may be thought of as subsets of dashboard components that specify additional related categories of information and/or data. For example, an infection risk category may include subsets related to specific risks (e.g., catheters). Data points may be selected by a user and/or recommended by the dashboard creator 404 based on data contained in a clinical data repository (e.g., the CDR 208) and/or clinical models. For example, if a certain dashboard component is selected, the dashboard creator 404 may provide related data points to the user for inclusion in the dashboard. When a dashboard is being formed, data points may be of a general nature, for example, specifying patient gender. When the dashboard is selected for use with a patient, data points may be associated with patient data, for example, specifying that the selected patient is female. Some data points may be of a general nature and applicable to all patients. For example, some data points may specify a certain healthcare standard and may remain unaltered by patient data.

The dashboard creator 404 is used to determine content associated with dashboard components (block 808). To associate content with data points and/or components, the dashboard creator 404 accesses the clinical decision supporter 206 via the CDR 208 to access clinical decision support mechanisms attached to data points. Detailed clinical models (DCMs), such as clinical element models (CEMs), may be used to structure, organize, and/or associate content, clinical decision support mechanisms, and/or associated data points. Dashboard components may be automatically associated with content based on these clinical models. A clinical model may provide format and rules and associations for the clinical model. Clinical models may be combined to form a dashboard component and drive information, alerts, and functionality available through the dashboard using the healthcare content, rules, and associations. For example, content related to treating a patient based on a particular use case may be associated with the appropriate data point. Such content may be displayed on the dashboard or associated with the dashboard for selection and closer inspection by a user at a later time.

The alert creator 406 is used by the dashboard creator 404 to determine alerts associated with dashboard components (block 810). The alert creator 406 of the illustrated example creates alerts based on aggregated data obtained from the clinical data repository 208 via the dashboard creator 404. Alerts may be based on a review of models that indicate certain data relates to an alert in a certain way. Alerts are intended to illustrate to a user when healthcare standards, patient information (e.g., test results), etc. are deviating from clinical standards and/or expected outcomes, for example. The alert creator 406 may create, gather, and/or assign rules to dashboards (e.g., data points within a dashboard) based on relevant healthcare standards. For example, if the dashboard creator 404 is creating a dashboard involving hospital-based conditions, the alert creator 406 may used aggregated data to assign a rule to a data point based on best-practices to avoid hospital-based conditions. Such a rule may specify, for example, that a catheter should be used for a certain amount of time.

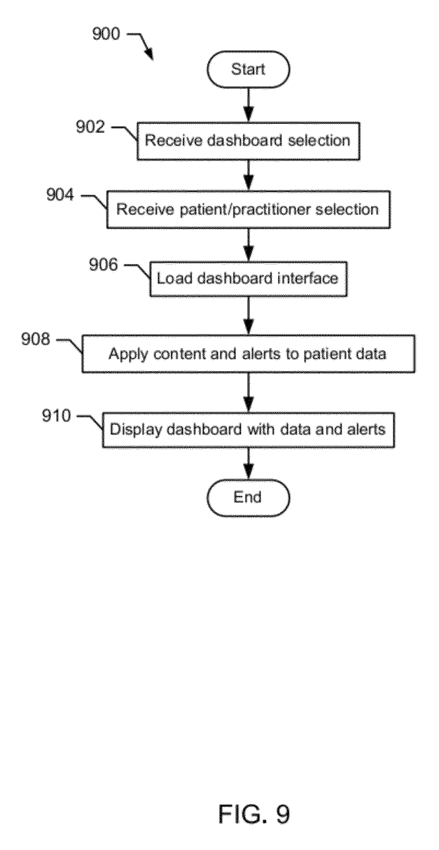

The dashboard creator 404 generates the dashboard interface (block 812) based on context parameters, categories, data points, content, and/or alerts. The dashboards generated by the dashboard creator 404 may be used in connection with a patient and/or practitioner as described below in connection with FIG. 9.

FIG. 9 illustrates a flow diagram of an example method 900 of using the dashboard provider 210 of FIG. 4. The example method 900 illustrates a manner in which a user may use a dashboard to facilitate a workflow and/or review process of patient and/or practitioner data. Initially, the selection receiver 402 receives a selection of a dashboard (block 902). Dashboards may be generated as described above in connection with FIG. 8. For example, a user may create and/or select a hospital-based condition dashboard.

The selection receiver 402 then receives a selection of a patient and/or practitioner to be displayed with the selected dashboard (block 904). For example, a user may select a single patient or a plurality of patients to be viewed in the dashboard. Additionally or alternatively, a user may select a practitioner and associated patients may be viewed in the dashboard. The dashboard creator 404 loads the selected dashboard interface (e.g., including dashboard components and data points) and the selected patient and/or practitioner (block 906). To load the selected dashboard, the dashboard creator 404 applies data associated with the selected patient and/or practitioner (e.g., patient data) to the dashboard components and/or data points. For example, if a dashboard component includes lab results, the dashboard creator 404 gathers lab results for the selected patient and loads them into the associated data points.

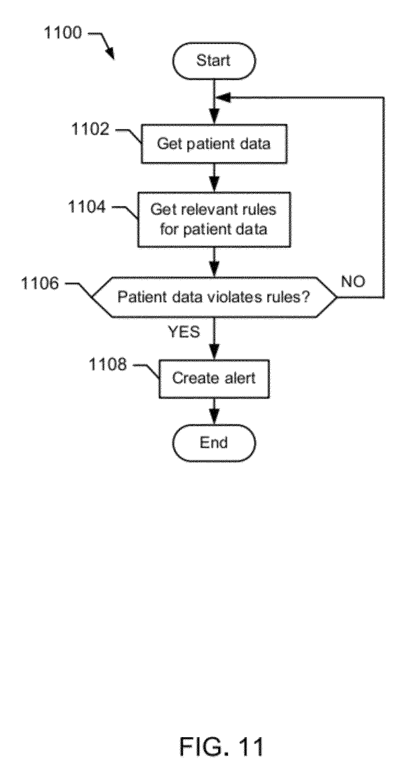

The dashboard creator 404 applies content and alerts to the patient data loaded into the dashboard (block 908). For example, the dashboard creator 404 executes content against the patient and/or practitioner data to render the dashboard visually and behaviorally. For example, content related to treating a patient based on a particular use case may be associated with a patient. Such content may be displayed on the dashboard or associated with the dashboard for selection and closer inspection by a user. For example, a patient may be prescribed a certain antibiotic and additional content (e.g., prescribing information) may be displayed on the dashboard upon selection of the antibiotic by the user. The alert creator 406 is used by the dashboard creator 404 to determine alerts associated with patient data. The alert creator 406 applies rules to the patient data to determine if patient care and/or data conform to accepted best practices. A method of applying alerts to patient data is described in greater detail below in connection with FIG. 11.

Once the dashboard creator 404 has applied content and alerts to patient and/or practitioner data, the dashboard presenter 408 displays the dashboard interface with the relevant data and/or alerts (block 910). The dashboard presenter 408 may present dashboards via, for example, a graphical user interface. The presented dashboard includes dashboard components with their associated data points, for example. The appropriate patient and/or practitioner data are displayed within at least some of the data points. Content associated with the patient and/or practitioner data are displayed and/or certain data points may be selected by a user to display additional content. Alerts are presented to the user based on the patient and/or practitioner data that violates patient care standards. Such alerts may be selected by the user to display additional content and/or a supplemental dashboard (e.g., additional information regarding best care practices). Example dashboards generated by the dashboard creator 404 are illustrated in FIGS. 5-7.

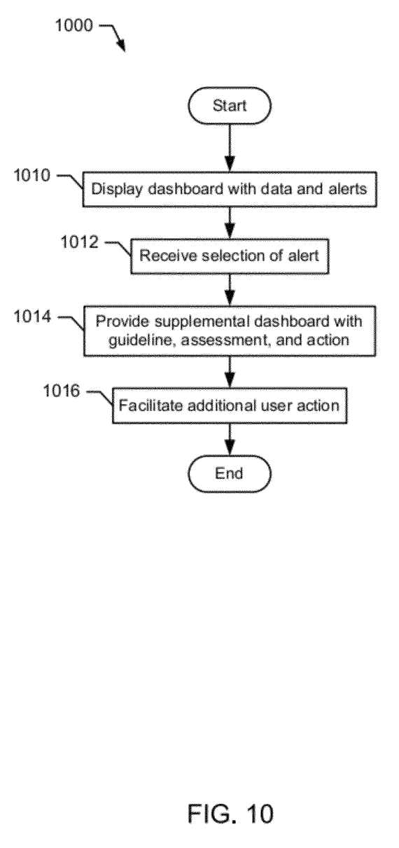

FIG. 10 illustrates a flow diagram of an example method 1000 of using the dashboard provider 210 of FIG. 4. The example method 1000 illustrates a manner in which a supplemental dashboard is generated.

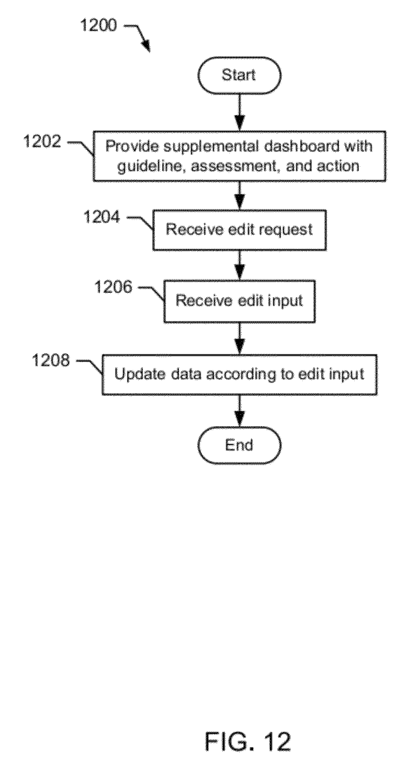

As described above with reference to FIG. 9, the dashboard presenter 408 displays the dashboard interface with relevant data and/or alerts for a patient and/or practitioner (block 1010). A user may select a data point and/or an alert displayed within a dashboard via the selection receiver 402 (block 1012). If the selection receiver receives a selection of data and/or an alert, the dashboard creator 404 provides a supplemental dashboard (block 1014). For example, a user may select an alert and/or patient data and additional content that provides additional information relating to patient best care practices may be displayed. The selection of a data point and/or alert allows a user to drill down within the dashboard for greater inspection of data points included in the dashboard and/or receive additional information related to the data point and/or alert. In some examples, a user selects an alert and the dashboard creator 404 provides a supplemental dashboard that contains guidelines, assessments, and actions to facilitate user action. A guideline is information related to clinical norms for the associated data point and/or patient data. An assessment is information related to the associated data point and/or patient data. The action facilitates additional user actions (block 1016) such as entering and order, suggesting a medication, editing a data point, etc. to assist the user in aligning patient care with clinical norms. An example of facilitating user action by allowing a user to edit patient information is described below in connection with FIG. 12.

FIG. 11 illustrates a flow diagram of an example method 1100 of using the dashboard provider 210 of FIG. 4. The example method 1100 illustrates a manner in which alerts may be applied to patient data. The alert creator 406 accesses patient data via the dashboard creator 404 (block 1002). The alert creator 406 accesses rules related to the patient data (block 1004). Rules are created by the alert creator 406 based on data points, dashboard components, and/or content. The rules are described above in connection with FIG. 8. If, for example, patient data relates to an amount of time a catheter has been used, the alert creator 406 access rules related to catheter best care standards. The alert creator 406 applies the rules to the patient data and determines if the patient data violates the rules (block 1006). For example, a rule related to catheter best practices may indicate an amount of time a catheter is to be used. If patient data indicates that a catheter has been used for a time longer than that indicated in the rule, the alert creator 406 determines that the patient data violates the rule. If patient data violates the rules, the alert creator 406 creates an alert for display in the dashboard (block 1008). The alert may be a physical indicator to illustrate to a user that patient data violates best care standards. If patient data does not violate the rules, control returns to block 1002.

FIG. 12 illustrates a flow diagram of an example method 1200 of using the dashboard provider 210 of FIG. 4. The method 1200 illustrates a manner of facilitating user action by allowing a user to edit patient information contained in a dashboard (e.g., the supplemental dashboard 610 of FIG. 6). As described above, the dashboard creator 404 creates a supplemental dashboard with patient and/or practitioner data, alerts, guidelines, assessments, and actions (block 1102). The dashboard creator 404 may facilitate user action by providing an edit option within the dashboard. The edit receiver 410 receives an edit request from a user (block 1104). The edit request may be, for example, the selection of an “edit orders” button 640 displayed in FIG. 6. The edit receiver 410 receives input from the user for the edit (block 1106). The input may be, for example, an update related to the patient information. The dashboard creator 404 updates patient and/or practitioner data according to the input (block 1108). For example, if a user inputs updated patient data, the dashboard creator 404 updates the dashboard, data points, associated content, and/or associated alerts.

FIG. 13 is a block diagram of an example processor platform 1300 capable of executing the instructions of FIG. 8, 9, 10, 11, and/or 12 to implement the example enterprise clinical information system of FIG. 2, the example dashboard provider of FIG. 4, and/or, more generally, the example healthcare environment of FIG. 1. The processor platform 1300 can be, for example, a server, a personal computer, an Internet appliance, a set top box, or any other type of computing device.

The processor platform 1300 of the instant example includes a processor 1312. For example, the processor 1312 can be implemented by one or more microprocessors or controllers from any desired family or manufacturer. The processor 1312 includes a local memory 1313 (e.g., a cache) and is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1316 may be implemented by flash memory and/or any other desired type of memory device. Access to the main memory 1314, 1316 is controlled by a memory controller.

The processor platform 1300 also includes an interface circuit 1320. The interface circuit 1320 may be implemented by any type of interface standard, such as an Ethernet interface, a universal serial bus (USB), and/or a PCI express interface.

One or more input devices 1322 are connected to the interface circuit 1320. The input device(s) 1322 permit a user to enter data and commands into the processor 1312. The input device(s) can be implemented by, for example, a keyboard, a mouse, a touchscreen, a track-pad, a trackball, isopoint and/or a voice recognition system.

One or more output devices 1324 are also connected to the interface circuit 1320. The output devices 1324 can be implemented, for example, by display devices (e.g., a liquid crystal display, a cathode ray tube display (CRT), etc.). The interface circuit 1320, thus, typically includes a graphics driver card.

The interface circuit 1320 also includes a communication device such as a modem or network interface card to facilitate exchange of data with external computers via a network 1326 (e.g., an Ethernet connection, a digital subscriber line (DSL), a telephone line, coaxial cable, a cellular telephone system, etc.).

The processor platform 1300 also includes one or more mass storage devices 1328 for storing software and data. Examples of such mass storage devices 1328 include floppy disk drives, hard drive disks, compact disk drives and digital versatile disk (DVD) drives. The mass storage device 1328 may implement a local storage device.

The coded instructions 1332 of FIG. 8, 9, 10, 11, and/or 12 may be stored in the local memory 1313, the mass storage device 1328, in the volatile memory 1314, in the non-volatile memory 1316, and/or on a removable storage medium such as a CD or DVD.

Although certain example methods, systems, apparatus, and articles of manufacture have been described herein, the scope of coverage of this patent is not limited thereto. On the contrary, this patent covers all methods, systems and articles of manufacture fairly falling within the scope of the claims of this patent.

What is claimed is:

1. A method for providing a healthcare dashboard, said method comprising:
providing a plurality of dashboard components containing selectable data points, wherein the plurality of dashboard components are associated with a plurality of types of healthcare content and are based on parameters received from a user;
automatically creating at least one alert when a data point departs from clinical norms, the clinical norms being defined in association with the dashboard components, wherein at least one data point is associated with patient data;
receiving a selection of at least one alert from a user; and
providing a supplemental dashboard in response to the selection, the supplemental dashboard containing additional selectable data points related to at least the selected alert, the additional data points including at least a guideline, an assessment, and an action to facilitate additional user action.

2. The method of claim 1, wherein the dashboard components provide information and functionality for user operation with respect to hospital-acquired conditions.

3. The method of claim 1, wherein the dashboard components are automatically associated with healthcare content based on a plurality of clinical models, each clinical model providing a format and one or more rules and associations for the clinical model, the clinical models combining to form a dashboard component and drive information, alerts and functionality available through the healthcare dashboard using the healthcare content, rules and associations.

4. The method of claim 1, wherein creating an alert includes defining rules based on clinical norms, applying the rules to patient data, and determining if the patient data violates the rules.

5. The method of claim 1, wherein the guideline is information related to clinical norms for the associated data point.

6. The method of claim 1, wherein the assessment is information related to patient data for the associated data point.

7. The method of claim 1, wherein the action facilitates at least one of entering an order, suggesting a medication, or editing a data point to align patient care with clinical norms.

8. A system for providing a healthcare dashboard, said system comprising:
a dashboard provider to:
provide a plurality of dashboard components containing selectable data points, wherein the plurality of dashboard components are associated with a plurality of types of healthcare content and are based on parameters received from a user;
automatically create at least one alert when a data point departs from clinical norms, the clinical norms being defined in association with the dashboard components, wherein at least one data point is associated with patient data;
receive a selection of at least one alert from a user; and
provide a supplemental dashboard in response to the selection, the supplemental dashboard containing additional selectable data points related to at least the selected alert, the additional data points including at least a guideline, an assessment, and an action to facilitate additional user action.

9. The system of claim 8, wherein the dashboard components provide information and functionality for user operation with respect to hospital-acquired conditions.

10. The system of claim 8, wherein the dashboard components are automatically associated with healthcare content based on a plurality of clinical models, each clinical model providing a format and one or more rules and associations for the clinical model, the clinical models combining to form a dashboard component and drive information, alerts and functionality available through the healthcare dashboard using the healthcare content, rules and associations.

11. The system of claim 8, wherein the guideline is information related to clinical norms for the associated data point.

12. The system of claim 8, wherein the assessment is information related to patient data for the associated data point.

13. The system of claim 8, wherein the action facilitates at least one of entering an order, suggesting a medication, or editing a data point to align patient care with clinical norms.

14. A tangible computer-readable storage medium comprising instructions that, when executed, cause a computing device to at least:
provide a plurality of dashboard components containing selectable data points, wherein the plurality of dashboard components are associated with a plurality of types of healthcare content and are based on parameters received from a user;
automatically create at least one alert when a data point departs from clinical norms, the clinical norms being defined in association with the dashboard components, wherein at least one data point is associated with patient data;
receive a selection of at least one alert from a user; and
provide a supplemental dashboard in response to the selection, the supplemental dashboard containing additional selectable data points related to at least the selected alert, the additional data points including at least a guideline, an assessment, and an action to facilitate additional user action.

15. The tangible computer-readable storage medium of claim 14, wherein the dashboard components provide information and functionality for user operation with respect to hospital-acquired conditions.

16. The tangible computer-readable storage medium of claim 14, wherein the dashboard components are automatically associated with healthcare content based on a plurality of clinical models, each clinical model providing a format and one or more rules and associations for the clinical model, the clinical models combining to form a dashboard component and drive information, alerts and functionality available through the healthcare dashboard using the healthcare content, rules and associations.

17. The tangible computer-readable storage medium of claim 14, wherein creating an alert includes defining rules based on clinical norms, applying the rules to patient data, and determining if the patient data violates the rules.

18. The tangible computer-readable storage medium of claim 14, wherein the guideline is information related to clinical norms for the associated data point.

19. The tangible computer-readable storage medium of claim 14, wherein the assessment is information related to patient data for the associated data point.

20. The tangible computer-readable storage medium of claim 14, wherein the action facilitates at least one of entering an order, suggesting a medication, or editing a data point to align patient care with clinical norms.
